(19) United States
(12) Patent Application Publication
(10) Pub. No.: US 2023/0303766 A1
(43) Pub. Date: Sep. 28, 2023

(54) LOW MELT COPOLYETHERESTER

(71) Applicant: ESTER INDUSTRIES LIMITED, Khatima (IN)

(72) Inventors: Balasundaram DILLYRAJ, Khatima (IN); Chandrakant Omkar VYAS, Khatima (IN); Gokal KUMAR, Khatima (IN)

(21) Appl. No.: 18/020,881

(22) PCT Filed: Aug. 6, 2021
(86) PCT No.: PCT/IN2021/050755

§ 371 Date: Feb. 10, 2023

(30) Foreign Application Priority Data
Aug. 10, 2020 (IN) 202011034280

(51) Int. Cl. C08G 63/183; C09J 167/02

(52) U.S. Cl. CPC C08G 63/183; C09J 167/025

(57) ABSTRACT

The present invention relates to a low melt copolyetherester based on terephthalic acid, isophthalic acid, aliphatic diols and polybutylene terephthalate. The melting point of the low melt copolyetherester is between 90° to 170° C.

This application claims the benefit of priority to provisional Indian application numbered 202011034280 filed on Aug. 10, 2020.

### FIELD OF THE INVENTION

A low melt copolyetherester based on terephthalic acid, isophthalic acid, aliphatic diols and polybutylene terephthalate. The melting point of the low melt copolyetherester is between 90° to 170° C.

### BACKGROUND OF THE INVENTION

Hot-melt adhesives, are materials which are applied to a substrate when molten and cooled to harden the adhesive layer, and are widely used for industrial applications.

If adhesive formulations are to be applied at temperatures below 150° C., they may be prepared using low molecular weight components or by incorporating a high wax content. Such formulations achieve low application viscosity but results in loss of adhesive properties.

Hot melt adhesives for elastic attachment application generally contain 20-35% polymer. Such polymer content results in high viscosity, and thus the typical application temperature is 160° C. or greater. To reduce the energy demands and glue burn-through (hot adhesive partially or completely melts the polymeric substrate) as well as the occupational risks associated with applying hot melt adhesives, there is a need to provide adhesives that are suitable for hot melt applications at lower temperatures.

U.S. Pat. No. 8,987,372 assigned to Henkel Corporation states that it provides low application temperature hot melt adhesives which exhibit desirable thermomechanical and viscoelastic properties. It uses at least one styrenic block copolymer i.e. a styrene content greater than 40 wt % based on the total weight of the copolymer to achieve adhesive properties.

U.S. Pat. No. 8,129,464 assigned to Bostik Inc. again talks about a low application temperature hot melt adhesive by utilizing a high softening point mid-block tackifier with SIS copolymer i.e. 10% to about 40% by weight of an elastomeric block copolymer, preferably styrene-isoprene-styrene (SIS) or styrene-butadiene-styrene (SBS).

U.S. Pat. No. 7,019,060 assigned to National Starch and Chemical Investment Holding Corp uses ethylene vinyl acetate copolymers (EVA) having vinyl acetate for achieving good adhesive properties at comparatively lower temperature.

There continues to be need in the art for low application temperature hot melt adhesives which is easy to process and use.

### SUMMARY OF INVENTION

An object of the present invention is to develop a low melt copolyetherester based on terephthalic acid, isophthalic acid and aliphatic diols, wherein the molar proportion of terephthalic acid is at least 80 to 98 mol %.

Another object of the present invention is to develop a low melt copolyetherester wherein the aliphatic diol content is at least 0 to 65 mol % of monoethylene glycol, 25 to 98 mol % diethylene glycol and optionally an additional glycol is added. The content of diols is decided based upon the overall quantity/proportion of acid.

Yet another object of the present invention is to develop a low melt copolyetherester wherein 100 mol % of the diol quantity and 25 to 50 weight % polybutylene terephthalate is used based upon overall quantity/proportion of acid

Further object of the invention is to develop a low melt copolyetherester having he melting point between 90° and 170° C.

Still further object of the invention is to develop a low melt copolyetherester in the form of chips/pellets, which can be used as an adhesive in textile industry.

### DETAILED DESCRIPTION OF THE INVENTION

### Definition of Terms

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a”, “an” and “the” are used to refer to one or to more than one (i.e., to at least one) of the grammatical object of the article.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 mole % should be interpreted to include not only the explicitly recited limits of 5 to 40 mole %, but also to include sub-ranges, such as 10 mole % to 30 mole %, 7 mole % to 25 mole %, and so forth, as well as individual amounts, including fractional amounts, within the specified ranges, such as 15.5 mole %, 29.1 mole %, and 12.9 mole %, for example.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### Abbreviations Used in the Invention

| | |
|---|---|
| PET | Polyethylene Terephthalate |
| RPET | Recycled polyethylene terephthalate |
| PCR | Post-consumer recycled |
| PBT | Polybutylene Terephthalate |
| PEG | Polyethylene glycol |
| DEG | Diethylene glycol |
| BHET | Bis(hydroxyethyl)terephthalate |
| SSP | Solid state polymerization |
| I.V. | Intrinsic viscosity |
| dl/gm | Deciliters per gram |
| meg/kg | Milliequivalents/kilogram |
| Wt % | Weight percentage |
| T_{g} | Glass transition temperature |
| T_{ch} | Crystallization temperature |
| Tₘ | Melting temperature |

A low melt copolyetherester based on terephthalic acid, isophthalic acid and aliphatic diols is developed wherein the molar proportion of terephthalic acid is at least 80 to 98 mol % based on the overall acid quantity, the aliphatic diol content at least 0 to 65 mol % of monoethylene glycol, 25 to 98 mol % diethylene glycol and optionally an additional glycol selected from the group consisting of polyethylene glycol 400 to polyethylene glycol 1500 and mixture thereof to make up 100 mol % of the diol quantity and 25 to 50 weight % polybutylene terephthalate. Other additives for preparation of low melt copolyetherester are selected from the class of stabilizers, pigments, optical brighteners, and antioxidants.

Additives, Stabilizers or optical brighteners can be selected from but are not limited to, antimony trioxide, cobalt acetate, phosphoric acid, thermal conductivity improvers (for PET) such as zinc oxide, titanium dioxide (available as Altris 500 from Huntsman). Ultraviolet light stabilizers such as resorcinol monobenzoates, phenyl salicylate and 2-hydroxybenzophenones; Hindered amine light stabilizers (HALS) such as benzotriazole, benzophenone, oxalanilide, cerium dioxide and the like.

Pigments may be selected from carbon blacks, phthalocyanines, quinacridones, nickel azo compounds, mono azo coloring agents, anthraquinones and perylenes and the like.

The antioxidants include but are not limited to irganox 1010 (PentaerythritolTetrakis(3-(3,5-di-tert-butyl-4-hydroxyphenyl)propionate), irganox 1076 (Octadecyl-3-(3,5-di-tert.butyl-4-hydroxyphenyl)-propionate),irgafos 126 (Bis-(2, 4-di-t-butylphenol) PentaerythritolDiphosphite) and irgafos 168 (Tris(2,4-ditert-butylphenyl)phosphite.

A diol is a chemical compound containing two hydroxyl groups (—OH groups). An aliphatic diol is also called a glycol. Terms diol or aliphatic diol are used interchangeably in the present invention.

The low melt copolyetherester chopped through underwater melt granulator or underwater strand granulator is produced in the form of chips/pellets having melting point of 90 to 170° C., preferably 120 to 150° C. can be used as an adhesive in textile industry.

### Quality Parameters

### Intrinsic Viscosity

Intrinsic viscosity (I.V.) is a measure of the molecular mass of the polymer and is measured by dilute solution using an Ubbelohde viscometer. All intrinsic viscosities are measured in a 60:40 mixture of phenol and s-tetrachloroethane with 0.5% concentration. The flow time of solvent and solution are checked under I.V. water bath maintained at temperature bout 25° C. The I.V., II, was obtained from the measurement of relative viscosity, ηr, for a single polymer concentration by using the Billmeyer equation:

IV=[η]=0.25[(RV−1)+3 ln RV]/c

Wherein η is the intrinsic viscosity, RV is the relative viscosity; and c is the concentration of the polymeric solution (in g/dL). The relative viscosity (RV) is obtained from the ratio between the flow times of the solution (t) and the flow time of the pure solvent mixture (t₀).

RV=nᵣₑₗ=Flow time of solution (t)/Flow time of solvant (t₀)

I.V. must be controlled so that process ability and end properties of a polymer remain in the desired range. Class ‘A’ certified burette being used for IV measurement for more accuracy.

### DSC Analysis

The Differential Scanning calorimeter (DSC) is a thermal analyzer which can accurately and quickly determine the thermal behavior of Polymers such as glass transition temperatures (Tg), crystallization exothermic peak temperatures (Tch), peak endotherm temperatures (Tm), heats of crystallization (ΔH) and heats of fusion for all materials. A Perkin-Elmer model Jade DSC was used to monitor thermal properties of all polymer samples at heating and cooling rates of 10° C. per minute. A nitrogen purge was utilized to prevent oxidation degradation.

### Crystallinity by DSC and DGC:

The Differential Scanning calorimeter (DSC) and Density Gradient Column (DGC) are used to calculate the crystallinity of polymer samples.

By DSC, the crystallinity is calculated by heat of fusion ((ΔH) of Tm1 (Heat 1 cycle) with specific heat of polymer. By DGC (Density Gradient Column), the crystallinity is calculated with the help of known standard balls floating at the Lloyds densitometer.

### Melt Viscosity and Melt Flow Index (MFI):

Melt viscosity and melt flow index both are tested using Tinius Olsen plastometer (MP 600). Granules are dried at 110° C. for 2 hours, Barrel temp 170° C., Load 2.16 kg

### Impact Strength:

Impact Strength of Film samples is tested by Dart Impact Tester.

Resin is dried at 100° C. for 3 hrs. Film is made by compression moulding using Collin Press. Then kept in Freezer for 8 hrs at below 8° C. and dried at 71° C. for 2 hrs.

Dart Impact of film samples is checked by a known dart weight by free fall method on centre of film.

### EXAMPLES

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Example 1

To a 2 M³ volume reactor equipped with a mechanical stirrer, a packed refluxing column, a nitrogen inlet and a heat source were added 27.1 kg of diethylene glycol, 36.6 kg of terephthalic acid, 21.04 gm of antimony trioxide (220 ppm as antimony) and 18.58 g of cobalt acetate (55 ppm as cobalt). Esterification was carried out at temperature of 240-260° C. under pressure up to 3.0 bars for 2-3 h. After completion of 90% esterification, the reactor was depressurized and phosphoric acid was added. The BHET produced was transferred into polycondensation reactor. PBT chips were added and the reaction mixture was kept on hold for 60 min for melting. Polycondensation reaction was carried out at temperature of 240-270° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.635 dl/g and throughput of product from reactor was more than 98.5% (yield).

The intrinsic viscosity (I.V.), melt viscosity, impact strength by making 300μ film and also the melting, the glass transition temperatures of the polymer was measured using DSC and the results are summarized in Table 1.

### Example 2

To a 2 M³ volume reactor equipped with a mechanical stirrer, a packed refluxing column, a nitrogen inlet and a heat source were added 12.4 kg of ethylene glycol, 16 wt. % DEG, 37.5 kg of terephthalic acid, 4.0 kg isophthalic acid, 21.04 gm of antimony trioxide (220 ppm as antimony) and 18.58 g of cobalt acetate (55 ppm as cobalt). Esterification was carried out at temperature of 240-260° C. under pressure up to 3.0 bars for 2-3 h. After completion of 90% esterification, the reactor was depressurized and phosphoric acid was added. The BHET produced was transferred into polycondensation reactor. PBT chips were added and the reaction mixture was held for 60 min for melting. Polycondensation reaction was carried out at temperature of 240-270° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.435 dl/g and throughput of product from reactor was more than 98.1% (yield).

The intrinsic viscosity (I. V.), melt viscosity, impact strength by making 300μ film and also the melting, the glass transition temperatures of the polymer was measured using DSC and the results are summarized in Table 1.

### Example 3

To a 0.2 M³ volume reactor equipped with a mechanical stirrer, a packed refluxing column, a nitrogen inlet and a heat source were added 9.4 kg of ethylene glycol, 16 wt. % DEG, 30.6 kg of terephthalic acid, 4.0 kg isophthalic acid, 21.04 gm of antimony trioxide (220 ppm as antimony) and 18.58 g of cobalt acetate (55 ppm as cobalt). Esterification was carried out at temperature of 240-260° C. under pressure up to 3.0 bars for 2-3 h. After completion of 90% esterification, the reactor was depressurized and phosphoric acid was added. The BHET was transferred into polycondensation reactor. PEG-1500 filtered solution was added and after mixing PEG 1500 for 10 minutes, PBT chips were added and the reaction mixture was held for 60 min for melting. Polycondensation reaction was carried out at temperature of 240-270° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.562 dl/g and throughput of product from reactor was more than 98.4% (yield).

The intrinsic viscosity (I.V.), melt viscosity, impact strength by making 300μ film and also the melting, the glass transition temperatures of the polymer was measured using DSC and the results are summarized in Table 1.

### Examples 4 to 7

Preparation of polymers. As outlined in Table 1, different polymer/polyesters were synthesized by using a procedure similar to that of Example 1. The melting temperature (Tₘ), crystallization temperature (T_{ch}), and T_{g} of the co-polyester were measured using DSC, and the results are summarized in Table 1.

### Example 8

Synthesis of low melt copolyetherester using post-consumer recycled (PCR) polyethylene terephthalate flakes.

To a 0.2 M³ volume reactor equipped with a mechanical stirrer, a packed refluxing column, a nitrogen inlet and a heat source were added 32.7 kg of post-consumer recycled flakes, 5.3 kg of MEG (for glycolysis of post-consumer recycled flakes), 12.8 kg diethylene glycol, 6.76 g of cobalt acetate (20 ppm as cobalt). Glycolysis was carried out at a temperature of 240-250° C. under pressure at a range of 2-3 bar for 1-2 h. the reactor was depressurized and phosphoric acid added in 10 min. Then BHET was transferred into polycondensation reactor. PEG 1500 filtered solution was added and after 10 min mixing PEG 1500, PBT was added. Polycondensation reaction was carried out at temperature 240-270° C. under pressure of less than 0.2 torr. When sufficient melt viscosity was achieved, the polymerization was stopped, and the polymer was emptied from reactor through die at the bottom. The molten polymer that comes out from the die as strand was cooled with cold water and then chopped to form pellets. The intrinsic viscosity of the amorphous polymer was 0.464 dl/g and throughput of product from reactor was about 98% (yield).

The molecular weight of the polymer can be significantly decreased by first loading the polymer pellets on a tumble dryer and heating the contents under a stream of nitrogen up to 60 to 90° C. over a period of 7 h to get the crystallized polymer. After crystallization, DM water pore and 1.0 to 1.5 bar N₂ pressure was applied to the dryer and the crystallized pellets are heated up to 115° C. for 15-20 h. After achieved final IV. Vacuum applied and polymer dried, cool and after sieving packed. This effects a solid state depolymerization and allows molecular weight to be significantly decreased. The intrinsic viscosity (I.V.) of the polymer was about 0.386 dl/g.

TABLE NO. 1
Analysis of Amorphous samples

| Parameter | Unit | Eg. 1 | Eg. 2 | Eg. 3 | Eg. 4 | Eg. 5 | Eg. 6 | Eg. 7 | Eg. 8 |
|---|---|---|---|---|---|---|---|---|---|
| I.V. | Dl/g | 0.635 | 0.435 | 0.562 | 0.827 | 0.579 | 0.533 | 0.527 | 0.464 |
| Tg1 | ° C. | 26.3 | 45.3 | ND | 43.6 | ND | ND | ND | ND |
| Tch1 | ° C. | 57.8 | ND | 89.4 | ND | 55.4 | 59.1 | ND | ND |
| Tm1 | ° C. | 132.2 | 101.9/125 | 132.1 | 104.3/127.4 | 129.9 | 140 | 143.7 | 122.4 |
| Delta H1 | J/g | 12.7 | 1.7/8.8 | 13.5 | 2.2/8.8 | 7.1 | 17 | 14.3 | 10.9 |
| Tg2 | ° C. | 26.6 | 43.5 | 21.0 | 42.7 | ND | 17.1 | 3.1 | 4.85 |
| Tch2 | ° C. | 75.9 | ND | 101.9 | ND | 78.2 | 67.6 | 48.6 | 61.6 |
| Tm2 | ° C. | 134.1 | ND | 135.8 | ND | 129.2 | 140.5 | 144.8 | 129.4 |
| Delta H2 | J/g | 8.7 | — | 5.3 | — | 12.2 | 14.1 | 20.3 | 14.1 |
| MFI @ 160° C. | g/10 min | 37 | 48.0 | 40 | — | 64 | 73 | 54 | 258 |
| Melt viscosity | Poise | 2473 | 1506.0 | 1820 | — | 1411 | 1053 | 832 | 450 |
| @ 160° C. | | | | | | | | | |
| Total Yield | wt % | 98.5 | 98.1 | 98.4 | 98.9 | 98.5 | 98.8 | 98.5 | 98.6 |

TABLE NO. 2
Analysis of Solid state polymerization samples

| Parameter | Unit | Eg. 1 | Eg. 2 | Eg. 3 | Eg. 4 | Eg. 5 | Eg. 6 | Eg. 7 | Eg. 8 |
|---|---|---|---|---|---|---|---|---|---|
| % of | % | 9.7 | 14.1 | 12.7 | 19.2 | 12.7 | 18.0 | 19.2 | 18.6 |
| crystallinity | | | | | | | | | |
| Tg 2 | ° C. | 25.1 | 41.3 | 17.2 | 41.5 | ND | ND | 1.7 | 3.1 |
| Tch 2 | ° C. | 69.6 | ND | 96.8 | ND | 72.7 | 62.5 | 36.9 | 61.1 |
| Tm 2 | ° C. | 135.1 | ND | 132.3 | ND | 132.1 | 141.6 | 152.7 | 128.5 |
| Impact | gm | 150 | 150 | 200 | 2000 | 500 | 300 | 500 | 500 |
| strength | | | | | | | | | |
| MFI at 160° C. | gms/ | 293 | 238 | 313 | MFI @ | 300 | 292 | 270 | 280 |
| | 10 min | | | | 280° C.: 66 | | | | |
| Melt viscosity | Poise | 310 | 370 | 320 | MV. @ | 292 | 331 | 335 | 350 |
| at 160° C. | | | | | 280° C.: 1354 | | | | |

1. A low melt copolyetherester based on terephthalic acid, isophthalic acid and aliphatic diols, wherein the molar proportion of terephthalic acid is at least 80 to 98 mol % based on the overall acid quantity, the diol content at least 0 to 65 mol % of monoethylene glycol, 25 to 98 mol % diethylene glycol and optionally an additional glycol selected from the group consisting of polyethylene glycol 400 to polyethylene glycol 1500 and mixture thereof to make up 100 mol % of the diol quantity and 25 to 50 weight % polybutylene terephthalate having melting point of between 90° and 170° C.

2. The low melt copolyetherester according to claim 1 is made preferably by a mixture of terephthalic acid and isophthalic acid in a mol ratio of 80:20 to 98:2 esterified with a mixture of monoethylene glycol, diethylene glycol and 1 to 10 mol %.

3. The low melt copolyetherester according to claim 1, having a composition of at least to 50 weight % polybutylene terephthalate most preferably 35 to 45 weight %.

4. The low melt copolyetherester according to claim 1, having a composition of at least 25 to 98 mol % diethylene glycol most preferable 30 to 50 mol %.

5. The low melt copolyetherester according to claim 1, having a composition of at least 2 to 65 mol % monoethylene glycol most preferable 50 to 60 mol %.

6. The low melt copolyetherester according to claim 1, having a melting point between 90 and 170° C. most preferably 120 to 150° C.

7. The low melt copolyetherester according to claim 1, having a glass transition temperature below 60° C.

8. The low melt copolyetherester according to claim 1, having a melting viscosity, measured according to ISO/DIN 1133 at 160° C., of not less than 200 poise and not more than 500 poise and at 280° C., of not less than 2000 poise.

9. The low melt copolyetherester according to claim 1, having a melt flow index, measured according to ASTM D 1238 at 160° C., less than 400 gm/10 min.

10. The low melt copolyetherester according to claim 1, having an impact strength, measured according to ASTM D 1709 of not less than 500 gm.

11. The low melt copolyetherester according to claim 1 prepared in form of chips/pellets and used as hot melt adhesive in textile industry.

12. The low melt copolyetherester according to claim 1, chopped through underwater melt granulator or underwater strand granulator.
